(19) United States
(12) Patent Application Publication
(10) Pub. No.: US 2010/0160714 A1
(43) Pub. Date: Jun. 24, 2010

(54) Hearing Aid

(75) Inventors: Tze Peng Chua, Singapore (SG); Kunibert Husung, Erlangen (DE); Dirk Junius, Mohrendorf (DE); Harald Klemenz, Furth (DE); Matthias Latzel, Eggoslheim (DE); Eng Cheong Lim, Singapore (SG); Nisha Shakila Ma, Singapore (SG); Yen Ling Elaine Tham, Singapore (SG)

Correspondence Address: LERNER GREENBERG STEMER LLP, P O BOX 2480, HOLLYWOOD, FL, 33022-2480, US

(73) Assignee: SIEMENS MEDICAL INSTRUMENTS PTE. LTD., Singapore (SG)

(21) Appl. No.: 12/643,535

(22) Filed: Dec. 21, 2009

Related U.S. Application Data
(63) Continuation of application No. PCT/SG2008/000495, filed on Dec. 22, 2008.

(30) Foreign Application Priority Data
Jul. 17, 2009 (EP) 09165778

(51) Int. Cl. H04R 25/00

(52) U.S. Cl. 600/25

(57) ABSTRACT

A hearing aid has a hearing aid component, a brain wave signal receiver configured to receive brain wave signals, and a hearing aid controller configured to control the hearing aid component dependent on the detected brain wave signals. Therefore the hearing aid can be controlled by the detected brain wave signals.

### CROSS-REFERENCE TO RELATED APPLICATION

This is a continuation, under 35 U.S.C. §120, of copending international application No. PCT/SG2008/000495, filed Dec. 22, 2008, which designated the United States; this application also claims the priority, under 35 U.S.C. §119, of European patent application No. 09165778, filed Jul. 17, 2009; the prior applications are herewith incorporated by reference in their entirety.

### BACKGROUND OF THE INVENTION

### Field of the Invention

A hearing aid is usually fitted in or behind the ear of the user to amplify the sound for the user. Some popular types of hearing aids include behind-the-ear (BTE) hearing aids, in-the-ear (ITE) hearing aids, in-the-canal (ITC) hearing aids, completely-in-the-canal (CIC) hearing aids, etc.

A hearing aid usually includes a hearing aid housing within which a microphone for collecting sound waves, a signal processing circuit (also referred to as a speech processing circuit) for processing the collected sound waves and a loudspeaker (which may also be referred to as a receiver in the field of hearing aids) may be housed. To provide power for the microphone, the signal processing circuit and the loudspeaker, the hearing aid usually includes a battery chamber housing, also referred to as a battery door, coupled to the hearing aid housing to receive a battery.

A hearing aid usually also includes a switch button for switching on and switching off the hearing aid, and a volume controller for adjusting the volume of the hearing aid. In some advanced hearing aids, one or more operation programs may be provided, such as customized operation programs for quiet situations and noisy situations. Accordingly, the hearing aid may include a selection mechanism, such as a selection button, for selecting an operation program.

To control a hearing aid, a user needs to manually adjust, control or program the hearing aid, e.g. by pressing the respective buttons provided on the hearing aid. With the increasing functions provided by the hearing aid and the decreasing size of the hearing aid, it becomes complicated and confusing for users. The users may need to refer to the manual for detailed instruction, or simply try and fail which is time-consuming, inconvenient and may damage the hearing aid. Especially for users not equipped with the knowledge to control the hearing aid, such as children and elder users, or for handicapped users, they may need to rely on other people to help them control the hearing aid. In addition, these users not equipped with the knowledge or ability may not be able to communicate the correct information/message to other people to adjust/control the hearing aid, thereby causing more errors and frustrations to users.

International patent disclosure WO 2008/097201 A1 describes a system and a method for processing brain wave signals in a brain computer interface system.

### SUMMARY OF THE INVENTION

It is accordingly an object of the invention to provide a hearing aid which overcomes the above-mentioned disadvantages of the prior art devices of this general type.

With the foregoing and other objects in view there is provided, in accordance with the invention a hearing aid. The hearing aid may include a hearing aid component, a brain wave signal receiver configured to receive brain wave signals, and a hearing aid controller configured to control the hearing aid component dependent on the received brain wave signals.

Other features which are considered as characteristic for the invention are set forth in the appended claims.

Although the invention is illustrated and described herein as embodied in a hearing aid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a block diagram of a hearing aid according to a first embodiment of the invention;

FIG. 2 is a block diagram of the hearing aid according to a second embodiment;

FIG. 3 is a block diagram of the hearing aid according to a third embodiment;

FIG. 4 is a block diagram of a hearing aid arrangement according to a first embodiment;

FIG. 5 is an illustration of the hearing aid arrangement according to a second embodiment; and

FIG. 6 is an illustration of the hearing aid arrangement according to a third embodiment.

### DETAILED DESCRIPTION OF THE INVENTION

In the drawings, like reference characters generally refer to the same parts throughout the different views. The drawings are not necessarily to scale, emphasis instead generally being placed upon illustrating the principles of the invention. The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

The word “exemplary” is used herein to mean “serving as an example, instance, or illustration”. Any embodiment or configuration described herein as “exemplary” is not necessarily to be construed as preferred or advantageous over other embodiments or configurations.

Various embodiments provide a hearing aid which may be controlled with more ease. Various embodiments provide a hearing aid which may be easily controlled according to the needs of users.

In various embodiments, a hearing aid may be provided, which may be automatically controlled by a user. In more detail, a neurologically controlled hearing aid may be provided.

In the context of this description, a “circuit” may be understood as any kind of a logic implementing entity, which may be hardware, software, firmware, or any combination thereof. Thus, in an embodiment, a “circuit” may be a hard-wired logic circuit such as an application-specific integrated circuit (ASIC) or a hard-wired logic gate structure, or a programmable logic circuit such as a programmable processor, e.g. a microprocessor (e.g. a complex instruction set computer (CISC) processor or a reduced instruction set computer (RISC) processor). A “circuit” may also be software being implemented or executed by a processor, e.g. any kind of computer program, e.g. a computer program using a virtual machine code such as e.g. Java.

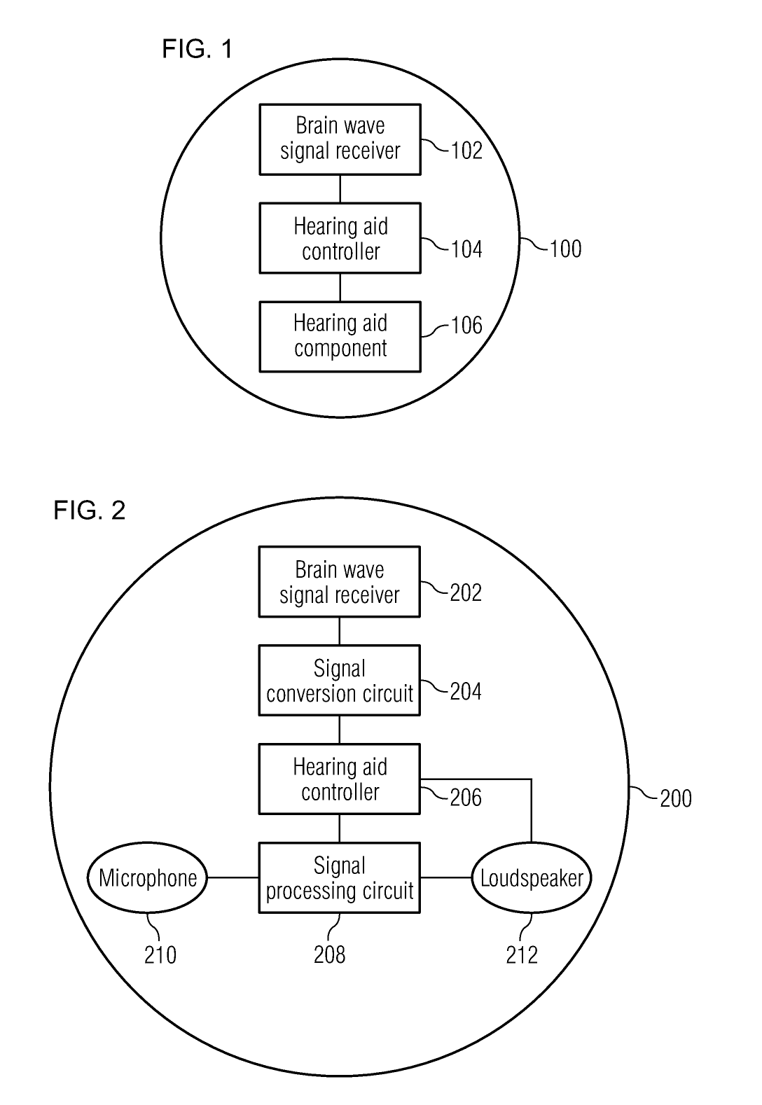

FIG. 1 shows a hearing aid according to an embodiment. In the embodiment, the hearing aid 100 includes a brain wave signal receiver 102, a hearing aid controller 104 and a hearing aid component 106.

The brain wave signal receiver 102 may be configured to receive brain wave signals, for example, from a brain wave signal detector through a brain wave signal interface. The hearing aid controller 104 may be configured to control the hearing aid component 106 dependent on the received brain wave signals.

In an embodiment, the hearing aid component 106 may be a conventional hearing aid component configured to collect sound waves and amplify the collected sound waves for outputting into the ear of a user of the hearing aid 100.

In one embodiment, the hearing aid controller 104 is configured to control the volume of the hearing aid component 106.

In another embodiment, the hearing aid controller 104 may be configured to switch on or switch off the hearing aid component 106.

In a further embodiment, the hearing aid controller 104 may be configured such that it can select from a plurality of stored hearing aid component operation programs, such that the selected hearing aid component operation program is running on the hearing aid component 106.

The hearing aid 100 may be implemented as a behind-the-ear hearing aid, an in-the-ear hearing aid, an in-the-canal hearing aid, a completely-in-the-canal hearing aid.

FIG. 2 shows a hearing aid according to another embodiment. The hearing aid 200 includes a brain wave signal receiver 202 configured to receive brain wave signals.

The hearing aid 200 further includes a signal conversion circuit 204 configured to convert the received brain wave signals to control signals. The control signals are provided to a hearing aid controller 206 of the hearing aid 200 to control the hearing aid 200.

In an example, the signal conversion circuit 204 is configured to convert the received brain wave signals to control signals based on frequency and/or amplitude of the received brain wave signals. Brain wave signals in different frequency and/or amplitude may represent different brain activities of the user, and thus can be converted to control signals corresponding to the brain activity of the user. In an example, the signal conversion circuit 204 may be implemented similar to the system described in international patent application WO 2008/097201 A1.

In another example, the signal conversion circuit 204 may be configured to convert the received brain wave signals to respective control signals based on a plurality of pre-determined control signal categories. The characteristics of brain wave signals may be analyzed to determine a plurality of categories, wherein each category may correspond to a category of control signals representing a particular brain activity or command or a user.

The hearing aid 200 includes a signal processing circuit 208, which is configured to process sound wave signals. A microphone 210 is used to collect sound waves and convert sound waves to electrical signals. More than one microphone may be included in the hearing aid 200, though only one microphone 210 is shown in FIG. 2. The microphone 210 is coupled with the signal processing circuit 208, such that the electrical signals are transmitted to the signal processing circuit 208 for further processing.

The signal processing circuit 208 may be configured to process the received electrical signals, e.g. by filtering, dynamically compressing, amplifying, etc. The thus processed electrical signal provided by the signal processing circuit 210 at an output thereof may then be transmitted to a loudspeaker 212, e.g. by a wire. The loudspeaker 212 converts the processed electrical signal to a sound wave signal for output to the ear of a user.

In an embodiment, the signal processing circuit 208 is coupled with the hearing aid controller 206, such that the hearing aid controller 206 may be configured to control the signal processing provided by the signal processing circuit 208. For example, depending on the control signal received from the signal conversion circuit 204, the hearing aid controller may control the signal processing circuit to increase or decrease the degree of amplification, or to filter the electrical signal determined from the sound wave signals in a selected range of frequency.

In an embodiment, the loudspeaker 212 may be coupled with the signal processing circuit 208, such that the signal processing circuit 208 may control the sound wave signal output from the loudspeaker 212 dependent on the control signal received from the signal conversion circuit 204.

The signal processing circuit 208, the microphone 210 and the loudspeaker 212 may include a hearing aid component according to an embodiment, which is used for collecting sound waves, processing sound waves, and outputting the processed sound waves. The thus formed hearing aid component may be integrated as one component, for example in one component housing, or may include several components departing from each other, depending on the configuration of the hearing aid component.

The signal conversion circuit 204, the hearing aid controller 206, and the signal processing circuit 208 may be mounted on a printed circuit board in an embodiment, such that they may be integrated within one hearing aid housing.

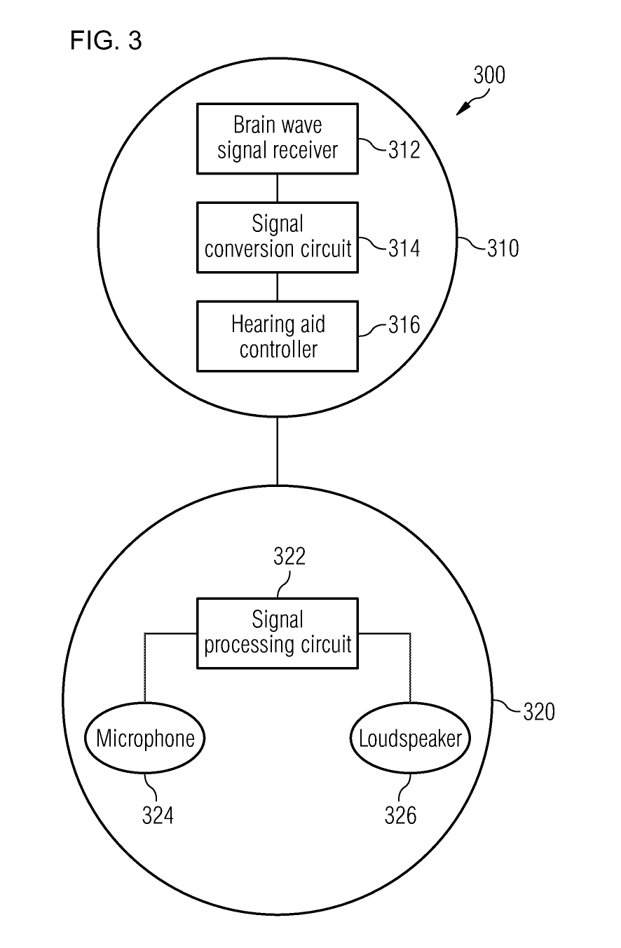

FIG. 3 shows a hearing aid according to another embodiment. In the embodiment of FIG. 3, a brain wave signal receiver 312, a signal conversion circuit 314 and a hearing aid controller 316 may be integrated as an external control component 310, which is separate from and connected to a hearing aid component 320 for processing of sound save signals. The hearing aid component 320 includes a signal processing circuit 322, a microphone 324 and a loudspeaker 326.

According to this embodiment, the hearing aid component 320 may be manufactured in a smaller size, e.g. as an in-the-ear hearing aid component, an in-the-canal hearing aid component, or a completely-in-the-canal hearing aid component, which may be positioned in the ear of the user. The external control component 310 may be separately positioned, e.g. behind the ear to save the space in the ear for the hearing aid component 320.

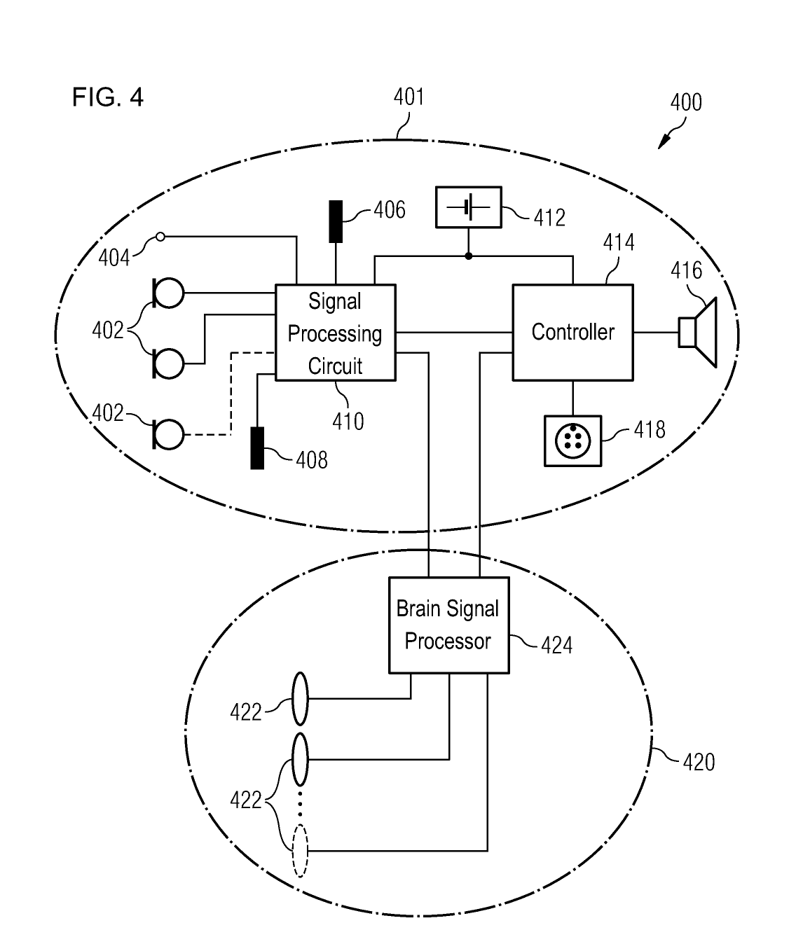

FIG. 4 shows a hearing aid arrangement according to an embodiment. The hearing aid arrangement 400 includes a hearing aid 401 according to the embodiments above and a brain wave signal detector 420 coupled to the hearing aid 401.

The hearing aid 401 includes a hearing aid component for the purpose of processing sound wave signals, and a hearing aid control component for the purpose of controlling the hearing aid component dependent on brain wave signals provided by the brain wave signal detector 420.

The hearing aid component may include one or more microphones 402 for collecting sound waves, e.g. from the surrounding environment. The hearing aid component may also be configured to collect sound directly from an audio source 404, e.g. a telephone or a FM system, through radio coils 406 or telephone coils 408 (also referred to as T-coils), such that background noise can be filtered out.

From the microphone 402, a radio coil 406 or a telephone coil 408, electrical signals derived from sound wave signals are transmitted to a signal processing circuit 410. The signal processing circuit 410 may then process the received electrical signals according to the functions provided by a signal processing circuit 410, such as filtering, A/D converting and amplifying. The signal processing circuit 410 is powered by a battery 412.

The processed electrical signal output from the signal processing circuit 410 is usually transmitted to a loudspeaker 416 for output to the ear of the user. The sound collecting components (including the microphone 402, the radio coils 406, the telephone coils 408), the signal processing circuit 410, and the sound outputting components (including the loudspeaker 416) are understood to constitute the hearing aid component.

In this embodiment, a hearing aid controller 414 is coupled to the hearing aid component to control the hearing aid component. Illustratively, the hearing aid controller 414 may be connected to the signal processing circuit 410 and the loudspeaker 416 for controlling the processing of electrical signals derived from sound wave signals and controlling the output of the processed electrical signals.

The hearing aid controller 414 is configured to control the hearing aid component dependent on brain wave signals received from a brain wave signal detector 420. In an example, the hearing aid controller 414 may be configured to carry out a method similar to the method described in international patent disclosure WO 2008/097201 A1.

For example, the brain wave signal detector 420 is used to detect brain wave signals of the user wearing the hearing aid 401.

The brain wave signal detector 420 may include a plurality of sensors 422 and a brain signal processor 424. In an example, the brain wave signal detector 420 is an Electroencephalogram detector, and according includes a plurality of Electroencephalogram sensors 422 and an Electroencephalogram signal processor 424. The Electroencephalogram sensors 422 may be electrodes for example, which may be connected to the Electroencephalogram signal processor 424 through respective wires. The Electroencephalogram sensors 422 may be positioned on a plurality of prescribed locations on the scalp of the user to measure the brain wave signals. For example, the Electroencephalogram sensors 422 may be fixed at the prescribed locations in a cap-shaped device for wearing by the user. The measured brain wave signals may then be processed, e.g. filtered or amplified, by the brain signal processor 424.

In an alternative embodiment, the brain wave signal detector may include sensors of a Magnetoencephalograph (MEG) or Electromyograph (EMG), for example. In another embodiment, the brain wave signal detector may include sensors of a Magnetic resonance imaging detector (MRI) or of a Nuclear magnetic resonance imaging detector (NMRI). In yet another embodiment, any sensor may be configured in accordance with any other suitable technique to detect another type of suitable brain wave signal which carries information about the thoughts of the user of the hearing aid which may be determined to generate corresponding hearing aid control signals.

The detected brain wave signal from the brain wave signal detector 420 is then transmitted to the hearing aid controller 414, e.g. through a brain wave signal detector interface (such as connecting wires) and a brain wave signal receiver (not shown). The detected brain wave signals may also be optionally transmitted to the signal processing circuit 410 of the hearing aid 401.

Upon receiving the detected brain wave signals, the hearing aid controller 414 may be configured to determine the controlling actions to be performed corresponding to the detected brain wave signals. A non-illustrated signal conversion circuit may be included in the hearing aid controller 414 or as a separate component of the hearing aid 401, and is configured to convert the detected brain wave signals to control signals.

In one embodiment, the signal conversion circuit may convert the detected brain wave signals to control signals based on frequency and/or amplitude of the detected brain wave signals. For example, brain activities representing different thought/command of the user may correspond to brain wave signals with different frequency and/or amplitude. By analyzing the frequency and/or amplitude of the received brain wave signal, a corresponding control signal indicating the thought/command of the user as represented by the brain wave signal may be determined.

In another embodiment, the signal conversion circuit may be configured to convert the received brain wave signals to respective control signals based on a plurality of pre-determined control signal categories. In an illustrative example, characteristics of brain wave signals may be analyzed to determine a plurality of categories of brain wave signals. Each category of brain wave signals may have a similar wave pattern or characteristics, and may correspond to a plurality of control signal categories representing various user commands. The plurality of control signal categories may for example include a control signal to switch on/off the hearing aid, a control signal to increase/decrease the volume, a control signal to select a particular hearing aid component operation program, etc.

Based on the pre-determined categories of brain wave signals, the signal conversion circuit may be configured to compare the detected brain wave signals with the pre-determined categories of brain wave signals, determine the category of brain wave signals that the detected brain wave signals belong to, and convert the detected brain wave signals to the control signals of a control signal category corresponding to the determined category of the detected brain wave signals.

The hearing aid controller 414 may then utilize the control signal provided by the signal conversion circuit above to control the signal processing circuit 410 and the loudspeaker 416 of the hearing aid 401. In an example, if the control signal indicates that a hearing aid component operation program for noisy environment is selected, the hearing aid controller 414 may control the signal processing circuit 410 to perform the processing according to the settings pre-defined by the operation program for noisy environment, such as increasing the level of amplification and increasing the level of noise reduction. In another example, if the control signal indicates that the user intends to decrease the volume of the hearing aid 401, the hearing aid controller 414 may control the signal processing circuit 410 and the loudspeaker 416 to decrease the level of amplification and output the sound waves in lower volume.

The plurality of hearing aid component operation programs may be stored in a on-illustrated memory of the hearing aid 401. In the situations where the stored hearing aid component operation programs need to be updated or changed, the hearing aid 401 may further include a programming connector 418 configured to connect the hearing aid 401 to a programming source, such as a computer or a programming device. The programming source thus transmits the updated or changed operation programs to the hearing aid 401 via the programming connector 418 in an easy and reliable manner.

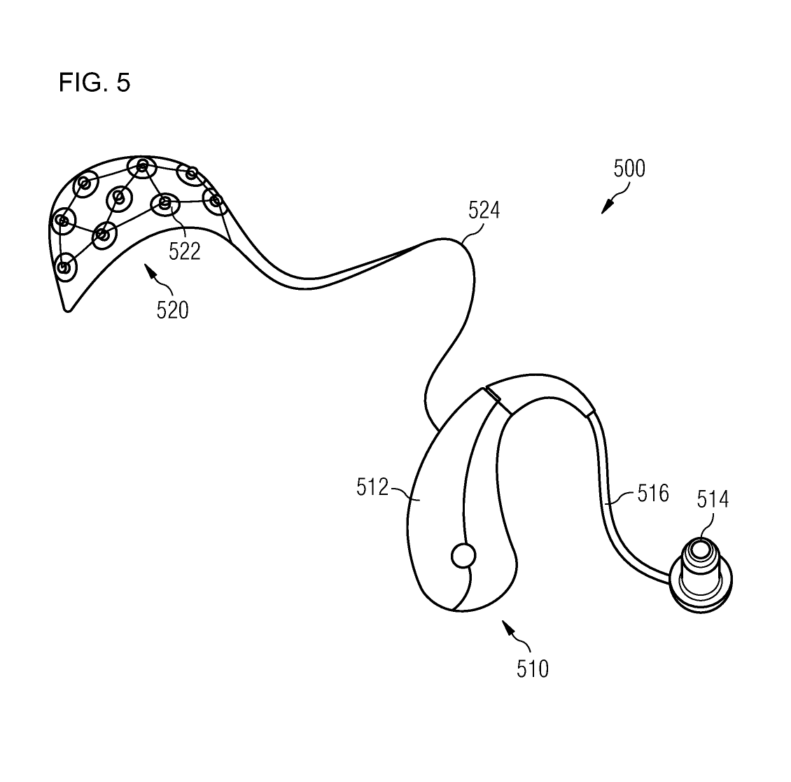

FIG. 5 shows a hearing aid arrangement according to an embodiment.

The hearing aid arrangement 500 includes a hearing aid 510 and a brain wave signal detector 520, wherein the hearing aid 510 and the brain wave signal detector 520 are connected to each other via a brain wave signal detector interface 524, such as wires as shown in FIG. 5. In another embodiment, the hearing aid 510 and the brain wave signal detector 520 may be coupled with each other in a wireless manner.

In one embodiment, the hearing aid 510 is a behind-the-ear hearing aid including a behind-the-ear component 512 configured to collect and process sound waves and including an earpiece 514 for fitting into the ear. The behind-the-ear component 512 may be connected to the earpiece 514 through a sound tube 516, if, e.g. a loudspeaker is positioned in the earpiece 514. In another example when the loudspeaker is positioned within the behind-the-ear component 512, the behind-the-ear component 512 may be connected to the earpiece 514 through a wire 516.

In the behind-the-ear component 512, a hearing aid controller as described in the above embodiments may be included to control the hearing aid 510.

The brain wave detector 520 in an embodiment is a cap-shaped device, wherein a plurality of Electroencephalogram sensors 522 are arranged in prescribed positions corresponding to the respective positions of the scalp or the head when the brain wave detector 520 is worn by the user. The brain wave detector 520 may also include a non-illustrated Electroencephalogram signal processor within the cap-shaped device or external to the cap-shaped device.

In other embodiments, the brain wave detector 520 may be a headset with integrated sensors as well.

The brain wave detector 520 may also be other types of detectors including other types of sensors and corresponding types of signal processors. Examples of other types of sensors may include but are not limited to Electroencephalogram sensors, Magnetoencephalography sensors, Electromyography sensors, Magnetic resonance imaging sensors, or Nuclear magnetic resonance sensors. Examples of corresponding types of signal processors may include but are not limited to an Electroencephalogram signal processor, a Magnetoencephalography signal processor, an Electromyography signal processor, a Magnetic resonance imaging signal processor, or a Nuclear magnetic resonance signal processor.

It is understood that in other embodiments the brain wave detector 520 may be other suitable types of detector including other suitable types of sensors and signal processor, which is configured in accordance with any other suitable technique to detect any other type of suitable brain wave signal carrying information about the thoughts of the user of the hearing aid for determining corresponding hearing aid control signals.

The hearing aid arrangement 500 thus utilizes brain wave signals of a user detected from the brain wave signal detector 520 to control the operation of the hearing aid 510.

The hearing aid according to the various embodiments above may be adapted to various situations by brain activity or thought control of the user in an automatic and user-friendly manner. This would provide benefit and convenience for users, especially the disabled users or users without knowledge of controlling the hearing aid.

Illustratively, various embodiments provide a brain computer interface as an implementation of a brain wave signal detector, wherein based on signals provided by an EEG system worn by the hearing aid user the desired modification of the operating state of the hearing aid, in other words, the desired control of the hearing aid, may be determined.

Thus, in various embodiments, the hearing aid user is enabled to control his or her hearing aid by mere thinking.

In various embodiments, the brain wave signal detector may include two or more wave signal receiver sensors (which may e.g. be implemented as diverting electrodes) in the region of the user's head, which may detect the brain wave signals, e.g. Electroencephalogram signals, and which may cause various modifications within the hearing aid (e.g. modification of the volume or modification of the hearing aid control program(s)) using characteristic time-dependent voltage course (or e.g. voltage distributions when using more than two sensors or electrodes).

As will be described in more detail below, the diverting electrodes (in general, the wave signal receiver sensors) may be integrated into the hearing aid (e.g. in case of a behind-the-ear hearing aid) or into earpieces of eyeglasses worn by the user.

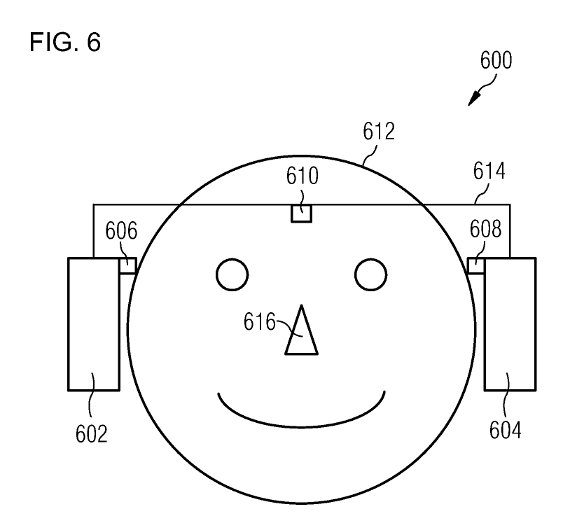

FIG. 6 shows a hearing aid arrangement 600 according to an embodiment. The hearing aid arrangement 600 may be worn by a user, wherein in this implementation, hearing aids (e.g. two behind-the-ear hearing aids) 602, 604 are worn by a user, e.g. a first hearing aid (e.g. a first behind-the-ear hearing aid) 602 at the user's right ear and a second hearing aid (e.g. a second behind-the-ear hearing aid) 604 at the user's left ear.

In various implementations, the first hearing aid 602 may be electrically coupled with a first diverting electrode 606 and the second hearing aid 604 may be electrically coupled with a second diverting electrode 608. Furthermore, a third diverting electrode 610 may be provided. The first diverting electrode 606, the second diverting electrode 608 and the third diverting electrode 610 may respectively be in direct physical contact with the skin of the user's head 612 so that electrical potential characteristics of an Electroencephalogram type may be detected from the user's head 612. The diverting electrodes 606, 608, 610 may be connected with each other and/or with one or both of the hearing aids 602, 604 via electrode connection lines (e.g. implemented as cables) 614.

As previously mentioned, in various embodiments, three Electroencephalogram sensors may be provided to measure the Electroencephalogram, since in various embodiments, it may be provided to use a differential amplifier to allow the detection of even very small voltage differences.

By way of examples, a ground electrode (providing a ground potential signal G) may be provided as a first one of the three electrodes, a reference electrode (providing a reference potential signal R) may be provided as a second one of the three electrodes, and a so-called active electrode (providing an active potential signal A) may be provided as a third one of the three electrodes. Then, a signal is measured and processed which may be determined as follows:

(active potential signal A−ground potential signal G)−(reference potential signal R−ground potential signal G).

This corresponds to the principle of a differential amplifier. Thus, by using three measurement electrodes (e.g. three diverting electrodes) a EEG signal characteristic would be provided which may be evaluated, which would be most sensitive for the activity of a current dipole, which has the same orientation as the active potential signal A with respect to the reference potential signal R.

By way of example, the active electrode (as an implementation of the first electrode 606) and the reference electrode (as an implementation of the second electrode 608) may be positioned at the left mastoid and the right mastoid (a bone behind the ear) or vice versa. In this case, brain waves may be detected very well, which run horizontally from the left to the right (or vice versa). Thus, this positioning of the electrodes is particularly suitable in case the relevant brain activity is running approximately in this direction as well. The position of the ground electrode (as an implementation of the third electrode 610) is rather arbitrary and thus could e.g. be arranged above the user's nose, e.g. in an eyeglass frame of a user's eyeglass (not shown).

In case it is desired to also measure other dipole orientations (e.g. vertical dipole orientation), correspondingly arranged electrodes (e.g. additional electrodes) may be provided in alternative implementations, e.g. one additional electrode may be positioned on the user's head (vertex). The maximum number of electrodes is arbitrary in general, wherein it should be mentioned that a higher number of electrodes (e.g. 10 to 16 electrodes) may also allow an accurate localization of the underlying activity centers within the user's head (this may also be referred to as dipole source analysis). In general, the achievable spatial resolution may increase with the number of provided electrodes, wherein the number of about 30 electrodes may be considered as a possible maximum number in a practicable implementation. Providing an even higher number may render the relation of the additional effort and cost for the additional electrodes to the achieved additional spatial resolution less economic.

In various embodiments, instead of a dipole source analysis, an evaluation logic may be provided, e.g. a pattern recognition circuit, which may e.g. be implemented as a component of the signal processing circuit (e.g. the signal processing circuit 208), and which may be configured to recognize e.g. using typical characteristics of the brain wave signals (e.g. EEG signals) as to whether the hearing aid user wants a change in the settings of the hearing aid.

An embodiment provides a hearing aid. The hearing aid may include a hearing aid component, a brain wave signal receiver configured to receive brain wave signals, and a hearing aid controller configured to control the hearing aid component dependent on the received brain wave signals.

The hearing aid according to various embodiments makes use of the brain wave signals detected from a user to control the hearing aid component, thereby providing a neurologically controlled hearing aid.

In an embodiment, the hearing aid component may be a conventional hearing aid component configured to collect sound waves and amplify the collected sound waves for outputting into the ear of a user of the hearing aid.

In one embodiment, the hearing aid controller is configured to control the volume of the hearing aid component and/or the sound/timbre of the hearing aid component. By way of example, the hearing aid controller may generate a volume control signal, which may be transmitted to an amplifier circuit of the hearing aid component to control the degree of amplification provided by the amplifier circuit, e.g. by increasing or decreasing the power level of the output of the amplifier circuit. In another example, the hearing aid controller may generate a volume control signal, which may be transmitted to a loudspeaker of the hearing aid to control the volume of sound output from the loudspeaker.

In another embodiment, the hearing aid controller may be configured to switch on or switch off the hearing aid component. For example, the hearing aid controller may generate an on/off control signal, which may be used to switch on or switch off the hearing aid component accordingly.

In a further embodiment, the hearing aid controller may be configured such that it can select from a plurality of stored hearing aid component operation programs. For example, the hearing aid controller may generate a program selection control signal, which may be used to select an operation program from the plurality of stored hearing aid component operation programs.

The plurality of stored hearing aid component operation programs may be various operation programs customized for a particular user, or for a particular environment, or for a particular use, etc. By way of example, the hearing aid component operation programs may include, but are not limited to, hearing aid component operation program for quiet environment, hearing aid component operation program for noisy environment, hearing aid component operation program for background noise reduction, hearing aid component operation program for music listening, and hearing aid component operation program for providing directionality. In other examples, the hearing aid component operation programs may include operation programs for amplifying sounds at lower frequencies, operation programs for amplifying sound frequencies only encountered in a specific setting, such as a dinner conversation or a crowded room, or a hearing aid component operation program for telephone use.

In an illustrative example, the hearing aid may currently work under the hearing aid component operation program for quiet situations, and the user of the hearing aid is moving from a quiet environment to a noisy environment. The brain wave signal detected from the user may indicate that the current operation program for quiet environment is not suitable and the operation program for noisy environment should be selected. Based on the detected brain wave signal, the hearing aid controller may be configured to select the operation program for noisy environment, which may provide higher level of sound amplification and improved noise reduction.

The hearing aid may include a memory configured to store the hearing aid component operation programs.

In an embodiment, the hearing aid may further include a programming connector configured to receive a hearing aid component operation program. The programming connector may be configured to be connected to a programming circuit, such as a computer or a specific programming device, for receiving one or more operation programs programmed by the programming circuit.

In an illustrative example, since the range of a user's hearing ability may change over time, the hearing aid component operation program stored in the hearing aid may need to be changed or updated. In other words, the hearing aid needs to be reprogrammed. By using the programming connector, the hearing aid may be reprogrammed in an easy and reliable manner, without the need to take out the memory from the hearing aid and then rewrite the memory, for example.

According to an embodiment, the hearing aid may further include a signal conversion circuit configured to convert the received brain wave signals to control signals. The control signals are provided to the hearing aid controller to control the hearing aid component.

In one embodiment, the signal conversion circuit may be configured to convert the received brain wave signals to control signals based on frequency and/or amplitude of the received brain wave signals. For example, brain activities representing different thought/command of the user may result as brain wave signals with different frequency and/or amplitude. By analyzing the frequency and/or amplitude of the received brain wave signal, a corresponding control signal indicating the thought/command of the user as represented by the brain wave signal may be determined.

In another embodiment, the signal conversion circuit may be configured to convert the received brain wave signals to respective control signals based on a plurality of pre-determined control signal categories. In an illustrative example, characteristics of brain wave signals may be analyzed to determine a plurality of categories of brain wave signals. Each category of brain wave signals may have a similar wave pattern or characteristics, and may correspond to a plurality of control signal categories representing various user commands. The plurality of control signal categories may for example include a control signal to switch on/off the hearing aid, a control signal to increase/decrease the volume, a control signal to select a particular hearing aid component operation program, etc. Based on the pre-determined categories of brain wave signals, the signal conversion circuit may be configured to compare the received brain wave signals with the pre-determined categories of brain wave signals, determine the category of brain wave signals that the received brain wave signals belong to, and convert the received brain wave signals to the control signals of a control signal category corresponding to the determined category of the received brain wave signals.

The brain wave signals in the embodiments may be Electroencephalogram (EEG) signals. In an alternative embodiment, the brain wave signals may be Magnetoencephalography (MEG) signals or Electromyography (EMG) signals, for example. In another embodiment, the brain wave signals may be brain wave signals determined using e.g. a Magnetic resonance imaging (MRI) technique or a Nuclear magnetic resonance imaging (NMRI) technique. In yet another embodiment, any other type of detected suitable brain wave signal which carries information about the thoughts of the user of the hearing aid which may be determined to generate corresponding hearing aid control signals may be provided.

In an embodiment, the hearing aid may include a brain wave signal detector interface coupled to the brain wave signal receiver. The brain wave signal detector interface may be configured to be coupled to a brain wave signal detector configured to detect brain wave signals. In this way, the brain wave signals detected by the brain wave signal detector may be transmitted to the brain wave signal receiver of the hearing aid through the brain wave signal detector interface. An example of the brain wave signal detector interface may be a wire or a radio connection, e.g. using Bluetooth or any other suitable radio technology.

The brain wave signal detector may include a plurality of sensors and a signal processor. In an example where the brain wave signals are EEG signals, the brain wave signal detector may include a plurality of Electroencephalogram sensors and an Electroencephalogram signal processor. The Electroencephalogram sensors may be a plurality of electrodes, for example. The plurality of Electroencephalogram sensors may be connected to the Electroencephalogram signal processor through wires.

In an alternative embodiment, the brain wave signal detector may include sensors of a Magnetoencephalograph (MEG) or Electromyograph (EMG), for example. In another embodiment, the brain wave signal detector may include sensors of a Magnetic resonance imaging detector (MRI) or of a Nuclear magnetic resonance imaging detector (NMRI). In yet another embodiment, any sensor may be configured in accordance with any other suitable technique to detect another type of suitable brain wave signal which carries information about the thoughts of the user of the hearing aid which may be determined to generate corresponding hearing aid control signals.

According to an embodiment, the hearing aid component may include a signal processing circuit (e.g. also referred to as speech processing circuit) being configured to process, such as filtering and/or amplifying, the electrical signal, e.g. received from a microphone. The signal processing circuit may include various processing circuits, such as a filtering circuit, an ND converter, an amplifier circuit.

The hearing aid component may include a microphone coupled with the signal processing circuit. The microphone collects sound wave signals, which are then transmitted to the signal processing circuit for further processing, such as noise reduction, amplifying, and/or A/D conversion. The microphone may be an omnidirectional microphone collecting sound in all directions, or may be a directional microphone positioned toward a particular direction to provide directional information.

In an embodiment, the signal processing circuit is coupled with the hearing aid controller, such that the hearing aid controller may be configured to control, for example, the degree of amplification, the processing of the sound wave signals according to the selected hearing aid component operation program, provided by the signal processing circuit.

The signal processing circuit as described above may be mounted on a printed circuit board. In another embodiment, other circuits or elements, such as the hearing aid controller, the memory, the signal conversion circuit, the programming connector, and the brain wave signal receiver, may be provided on the printed circuit board as well.

The hearing aid component may also include a loudspeaker, which may be coupled to the signal processing circuit to receive the processed signals and to output sound waves to be emitted into the ear of the user of the hearing aid. In an embodiment, the loudspeaker may be coupled with the hearing aid controller, such that the hearing aid controller may control the output of sound waves from the loudspeaker.

In an embodiment, the hearing aid component and the hearing aid controller may be integrated within one hearing aid housing. In another embodiment, the hearing aid component may be within a hearing aid housing and the hearing aid controller may be a separate device connected to the hearing aid housing through wires or any other suitable signal transmission technology such as e.g. any suitable radio technology, e.g. Bluetooth.

The hearing aid as described in the above embodiments may be a behind-the-ear hearing aid, an in-the-ear hearing aid, an in-the-canal hearing aid, a completely-in-the-canal hearing aid, to cater for various requirements of users.

According to an embodiment, the hearing aid component is a binaural hearing aid component. The binaural hearing aid component may provide improved sound quality and natural sound experience for users.

In an embodiment, the binaural hearing aid component may include a left hearing aid unit and a right hearing aid unit, which may be arranged in separate hearing aid housings and may be respectively positioned at the left ear and the right ear of a user. Each of the left hearing aid unit and the right hearing aid unit may be configured to collect sound waves and process the collected sound waves. For example, each of the left hearing aid unit and the right hearing aid unit may include a microphone for collecting sound wave signals, a signal processing circuit for processing collected sound wave signals, and a loudspeaker for outputting the processed signals.

The hearing aid controller as described in the above embodiments may be arranged together with either one of the left hearing aid unit or the right hearing aid unit in one of the left or the right hearing aid housing, or may be arranged in a separate controller device connected to both the left hearing aid unit and the right hearing aid unit.

The left hearing aid unit and the right hearing aid unit may be configured to communicate with each other. In one example, the left hearing aid unit and the right hearing aid unit may be configured to communicate the received brain wave signals between each other, such that the left hearing aid unit and the right hearing aid unit may be controlled dependent on the received brain wave signals. In another example, the left hearing aid unit and the right hearing aid unit may be configured to communicate signals regarding classification of the environment with each other in order to, e.g., determine the level of noise reduction performed by the left hearing aid unit and the right hearing aid unit. In other examples, control signals regarding the selected hearing aid operation program or other settings of the hearing aid may be communicated between the left hearing aid unit and the right hearing aid unit, such that the left hearing aid unit and the right hearing aid unit are configured to process sound wave signals according to the selected hearing aid operation program or the settings defined by the control signals.

In an embodiment, the communication between the left hearing aid unit and the right hearing aid unit is synchronized, such that the left hearing aid unit and the right hearing aid unit work as a synchronized hearing aid system. This would help to achieve an improved hearing experience and help to better localize the sound.

In one embodiment, the communication between the left hearing aid unit and the right hearing aid unit may be in a wireless manner. For example, the left hearing aid unit and the right hearing aid unit may be configured to communicate with each other using electromagnetic transmission, such as the e2e (ear-to-ear) Wireless™ technology with FSK (Frequency Shift Keying) modulation, or other suitable radio technologies.

In other embodiments, the communication between the left hearing aid unit and the right hearing aid unit may be in a wired manner, e.g. through wires connected between the left hearing aid unit and the right hearing aid unit.

The left hearing aid unit and the right hearing aid unit described in the embodiments above may be embodied as a behind-the-ear hearing aid unit, an in-the-ear hearing aid unit, an in-the-canal hearing aid unit, or a completely-in-the-canal hearing aid unit, depending on the configuration of the hearing aid.

Another embodiment relates to a hearing aid arrangement. The hearing aid arrangement may include a hearing aid according to the above embodiments, and may include a brain wave signal detector coupled to the hearing aid.

The brain wave signal detector may include a plurality of Electroencephalogram sensors and an Electroencephalogram signal processor. The Electroencephalogram sensors may be positioned on the scalp or the head of a user to collect signals.

In an alternative embodiment, the brain wave signal detector may include sensors of a magnetoencephalograph (MEG) detector and a magnetoencephalography signal processor, or sensors of an electromyograph (EMG) detector and an electromyography signal processor, for example. In another embodiment, the brain wave signal detector may include sensors of a magnetic resonance imaging detector (MRI) and a magnetic resonance imaging signal processor, or sensors of a nuclear magnetic resonance imaging detector (NMRI) and a nuclear magnetic resonance signal processor. In yet another embodiment, any sensor may be configured in accordance with any other suitable technique to detect another type of suitable brain wave signal which carries information about the thoughts of the user of the hearing aid which may be determined to generate corresponding hearing aid control signals, and any corresponding signal processor may be included in the brain wave signal detector for processing the detected brain wave signal.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A hearing aid, comprising:
a hearing aid component;
a brain wave signal receiver configured for receiving brain wave signals; and
a hearing aid controller controlling said hearing aid component dependent on received brain wave signals.

2. The hearing aid according to claim 1, wherein said hearing aid controller is configured to control at least one of a volume of said hearing aid component, a sound of said hearing aid component and a timbre of said hearing aid component.

3. The hearing aid according to claim 1, wherein said hearing aid controller is configured to switch on or switch off said hearing aid component.

4. The hearing aid according to claim 1, wherein said hearing aid controller is configured such that said hearing aid controller can select from a plurality of stored hearing aid component operation programs.

5. The hearing aid according to claim 4, wherein the hearing aid component operation programs are programs selected from a group of programs consisting of:
hearing aid component operation program for quiet environment;
hearing aid component operation program for noisy environment;
hearing aid component operation program for background noise reduction;
hearing aid component operation program for music listening;
hearing aid component operation program for providing directionality; and
hearing aid component operation program for telephone use.

6. The hearing aid according to claim 4, further comprising a memory configured to store the hearing aid component operation programs.

7. The hearing aid according to claim 1, further comprising a programming connector configured to receive a hearing aid component operation program.

8. The hearing aid according to claim 1, further comprising a signal conversion circuit configured for converting detected brain wave signals to control signals which are forwarded to said hearing aid controller.

9. The hearing aid according to claim 8, wherein said signal conversion circuit is configured to convert the received brain wave signal to the control signals based on at least one of a frequency and an amplitude of the received brain wave signals.

10. The hearing aid according to claim 8, wherein said signal conversion circuit is configured to convert the received brain wave signals to the control signals based on a plurality of pre-determined control signal categories.

11. The hearing aid according to claim 1, wherein the received brain wave signals are signals selected from the group of signals consisting of:
electroencephalogram signals;
magnetoencephalography signals;
electromyography signals;
magnetic resonance imaging signals; and
nuclear magnetic resonance imaging signals.

12. The hearing aid according to claim 1, further comprising a brain wave signal detector interface coupled to said brain wave signal receiver, said brain wave signal detector interface is configured to be coupled to a brain wave signal detector configured to detect brain wave signals.

13. The hearing aid according to claim 1, wherein said hearing aid component includes a signal processing circuit configured to process sound wave signals.

14. The hearing aid according to claim 13, wherein said hearing aid component includes a microphone coupled with said signal processing circuit.

15. The hearing aid according to claim 13, wherein said signal processing circuit is coupled with said hearing aid controller.

16. The hearing aid according to claim 1, wherein said hearing aid component includes a loudspeaker coupled with said hearing aid controller.

17. The hearing aid according to claim 1, further comprising a hearing aid housing, said hearing aid component and said hearing aid controller are integrated within one said hearing aid housing.

18. The hearing aid according to claim 1, wherein said hearing aid component is a binaural hearing aid component.

19. The hearing aid according to claim 18, wherein said binaural hearing aid component includes a left hearing aid unit and a right hearing aid unit.

20. The hearing aid according claim 19, wherein said left hearing aid unit and said right hearing aid unit are configured to communicate the received brain wave signals between each other.

21. A hearing aid configuration, comprising:
a hearing aid, comprising:
a hearing aid component;
a brain wave signal receiver configured to receive brain wave signals;
a hearing aid controller configured to control said hearing aid component dependent on received brain wave signals; and
a brain wave signal detector coupled to said hearing aid.

22. The hearing aid configuration according to claim 21, wherein:
said brain wave signal detector contains a plurality of sensors selected from a group of sensors consisting of electroencephalogram sensors, magnetoencephalography sensors, electromyography sensors, magnetic resonance imaging sensors, and nuclear magnetic resonance sensors; and
said the brain wave signal detector further having a processor selected from a group of processors consisting of an electroencephalogram signal processor, a magnetoencephalography signal processor, an electromyography signal processor, a magnetic resonance imaging signal processor, and a nuclear magnetic resonance signal processor.
